(19) United States
(12) Patent Application Publication
(10) Pub. No.: US 2005/0092118 A1
(43) Pub. Date: May 5, 2005

(54) Internal safety structure for toasters

(75) Inventor: Kwok Ping Wong, Hong Kong (CN)

Correspondence Address: Mr. Eric Chan, 42 Pin Oaks Drive, Phoenixville, PA, 19460, US

(73) Assignee: Yorkwell Industries Limited, Hong Kong (CN)

(21) Appl. No.: 10/797,420

(22) Filed: Mar. 6, 2004

(30) Foreign Application Priority Data
Nov. 3, 2003 (HK) 03107911.8

(51) Int. Cl. F16H 1/04

(52) U.S. Cl. 74/422; 74/421 A

(57) ABSTRACT

The present invention discloses an internal safety structure for toasters comprising a circuit board (12), a motor (3), a lifting rack (17) and others. The motor (3) is a low voltage direct current motor driving the lifting rack (17) to move upwards or downwards through a set of gears, a set of clutch gears and a driving gear bar (19). On the circuit board (12), an upper sensor (15) and a lower sensor (16) are installed to sense the lifting level of the lifting rack (17), and a transformer (13) is installed to reduce the voltage of alternating current of power to the circuit board (12) and the motor (3) through a set of diode rectifiers changing alternating current to direct current. The present invention is of simple and reliable construction, susceptible of low production costs and consumes low energy. It is economical and durable and produces less noise.

### BACKGROUND OF THE INVENTION

The present invention relates to an electric heating structure for kitchen equipment and more particularly pertains to an internal structure for toasters which is driven by a low voltage direct current motor.

Toasters have become the necessities for families, cafeterias and restaurants for a long time. The basic internal structure of a conventional two-slice toaster available in the marketplace has three mica sheets which are wrapped in nichrome wire as heating wire and are spaced parallel to each other to form two slots. The width of each slot is approximately 36 mm, which is just fit for inserting a slice of bread. A holder is placed inside the slot to hold the bread slice. One end of the holder connects to one surface of a lifting rack. The other surface of the lifting rack has an insulating bar and a metal piece on it. The lifting rack connects to an exposed handle. A circuit board is disposed in a position corresponding to the insulating bar and the metal piece and on which an electromagnet, capacitors, resistors, transistors, bipolar electric contacts, electric conducting metal strips, an electric wire connected to a plug and so forth are installed. To use the toaster, the user inserts the plug to a power socket and inserts a slice of bread into each slot. The user then presses down the handle to drive the lifting rack to slide downwards to the bottom of the toaster. By so doing, the holder is driven downwards simultaneously. The insulating bar on the lifting rack is driven downwards to push the electric conducting metal strips apart to press against the bipolar electric contacts and thus the circuit is connected to supply power to the electromagnet. The electromagnet then generates magnetic force to attract the metal piece so that the holder stays in the bottom of the toaster. After the circuit is connected, the heating wire is heated up and emits infrared radiation to heat up and dry the slices of bread. The capacitors and the resistors on the circuit board function together as a timer. When the capacitor stores electrical charge up to a certain level and a certain level of power supply voltage is reached, it automatically cuts off the power supply to the electromagnet. The magnetic force then disappears and the lifting rack is pulled upwards by a spring above. The lifting rack brings the holder to rise simultaneously and thus the slices of bread pops out. When the lifting rack rises, the insulating bar moves upwards and is detached from the electric conducting metal strips, thereby cutting off the circuit to stop the heating wire from heating continuously.

Toasters available in the marketplace operate with high voltage alternating current such as 110V in the United States and 220V to 250V in European and Asian countries. If the handle or the lifting rack or the holder fails to move upwards or downwards and the power supply cannot be cut off in time, it may burn the bread or even the toaster and in serious cases, it may cause fire resulting in loss of valuables and even human lives and so it is dangerous.

There are toasters in the marketplace which are equipped with safer internal structure. As illustrated in FIGS. 1 and 2 which show the internal structure of such a toaster, the toaster is constructed in a manner that no handle is used. The construction of the toaster is to use a motor together with a circuit board to control the operation of different components, the main structure of which comprises a circuit board 2′, a motor 3′, a lifting rack driving latch 4′, a limit switch 6′, a heating wire driving latch 11′, a lifting rack 12′, a holder 13′ and so forth. To use the toaster, the user inserts the plug to a power socket. The capacitors on the circuit board limit the electric current and reduce the voltage to supply power to the circuit board 2′ and the motor 3′. The user then inserts the slices of bread into the holder 13′ and the photoelectric switch 18′ is switched on automatically. The circuit board 2′ then gives instructions, and the motor 3′ immediately drives the lifting rack driving latch 4′ to rotate anti-clockwise, thereby driving the lifting rack 12′ as well as the holder 13′ to descend simultaneously. The motor 3′ and the lifting rack driving latch 4′ continue to rotate until the limit switch 6′ is contacted and they stop rotating. When the lifting rack 12′ descends, the heating wire driving latch 11′ descends simultaneously, thereby turning on the heating wire switch and causing the heating wire to heat up and send electrical signals to the circuit board 2′. On the circuit board 2′, there is an integrated circuit having timer function which starts to count the time. Upon expiration of the preset time, the circuit board 2′ gives instructions, the motor 3′ then immediately drives the lifting rack driving latch 4′ to rotate anti-clockwise and drives the lifting rack 12′ as well as the holder 13′ to ascend simultaneously. The motor 3′ and the lifting rack driving latch 4′ continue to rotate anti-clockwise until the limit switch 6′ is contacted and they stop rotating. When the lifting rack 12′ ascends, the heating wire driving latch 11′ ascends simultaneously and is detached from the heating wire switch, thereby cutting off the power supply to stop the heating wire from heating continuously.

Toasters with the aforesaid internal structure do not suffer from malfunctions of the handle or the lifting rack and so they are safer than typical toasters. However, the components of such toasters are operated by the high voltage alternating current motors. Noise produced is relatively loud. If the motor is out of order or overloaded, or if the capacitors are out of order, the power supply may not be cut off in time, causing a long period of overheating of the heating wire. The bread and the toaster may be burnt, and fires may be resulted causing loss of valuables or even human lives.

Therefore, the internal structure of the toasters available in the marketplace still cannot meet the requirements of consumers.

### BRIEF SUMMARY OF THE INVENTION

In view of the aforesaid disadvantages now present in the prior art, the present invention provides an internal safety structure for toasters which is driven by a low voltage direct current motor. It is of simple and reliable construction and is susceptible of low production costs. It consumes low energy. It is economical and durable and produces less noise.

To attain this, the present invention generally comprises a circuit board, a motor, a lifting rack and other components, which is characterized in that the motor is a low voltage direct current motor which drives the lifting rack to move upwards or downwards through a set of gears, a set of clutch gears and a driving gear bar; on the circuit board, an upper sensor and a lower sensor are installed to sense the lifting level of the lifting rack; on the circuit board, there is an integrated circuit which contains custom software to preset the operation and control programs; on the circuit board, a transformer is installed to reduce the voltage of the alternating current, which supplies power to the circuit board and the motor through a set of diode rectifiers changing the alternating current to direct current.

The set of gears comprises an endless screw which connects and rotates with the motor, and two or more straight-tooth gears which are intermeshed with one another and mesh and rotate with the motor. One side of the straight-tooth gears meshes with one side of the set of clutch gears.

The set of clutch gears comprises a transmission shaft and a clutch straight-tooth gear, a clutch spring and two or more intermeshed clutch gears which are installed on the transmission shaft. One side of the clutch gears meshes with the straight-tooth gear. One side of the clutch straight-tooth gear meshes with the driving gear bar. When the motor rotates, the set of gears drives one clutch gear in the set of clutch gears to rotate. The rotating clutch gear is pushed by the tension which is created by the clutch spring towards the second clutch gear and drives it to rotate. The second clutch gear drives the clutch straight-tooth gear to rotate through the transmission shaft. The clutch straight-tooth gear drives the driving gear bar to move upwards or downwards. When the lifting rack is out of order and becomes immovable, the driving gear bar cannot move upwards or downwards and so the clutch straight-tooth gear and the second clutch gear cannot rotate smoothly. When the first clutch gear is driven to rotate by the motor and the set of gears, the first clutch gear compresses the clutch spring and moves away from the second clutch gear. The first clutch gear and the second clutch gear skid at the point of contact, thus releasing the driving force generated by the rotation of the motor.

The driving gear bar is connected to the lifting rack securely. The teeth on one side of the driving gear bar mesh with one side of the clutch straight-tooth gear.

The lifting rack has a latch disposed in a position corresponding to the upper sensor and the lower sensor. When the lifting rack ascends to a horizontal position corresponding to that of the upper sensor, the latch contacts the upper sensor and the upper sensor immediately sends electrical signals to the circuit board. The preset programs of the integrated circuit of the circuit board control the motor to stop rotating. The lifting rack is then stopped from ascending continuously. When the lifting rack descends to a horizontal position corresponding to that of the lower sensor, the latch contacts the lower sensor and the lower sensor then immediately sends electrical signals to the circuit board. The preset programs of the integrated circuit of the circuit board control the motor to stop rotating. The lifting rack is then stopped from descending continuously.

One side of the lifting rack connects to a holder placed inside the toaster slots and the other side is connected to the driving gear bar. The upward or downward movements of the driving gear bar drive the lifting rack to move upwards or downwards accordingly. The lifting rack drives the slices of bread on the holder to move upwards or downwards accordingly.

The integrated circuit of the circuit board contains custom software to preset timing for the programs. It automatically cuts off the power supply to the motor after the expiration of the preset time limit, so as to stop the motor from rotating continuously, thus preventing the motor or other components from malfunctioning. The preset time limit is 5 to 30 seconds.

The power supply of the heating wire uses a relay as a switch. The relay is electrically connected to the power source, the circuit board and the heating wire respectively, and is operated and controlled by the preset programs of the integrated circuit of the circuit board. Upon completion of the preset programs, the power supply to the relay is automatically cut off and the relay immediately cuts off the power supply to the heating wire. When the descending procedure of the lifting rack functions improperly, the lower sensor does not send any electrical signal to the circuit board, and the circuit board does not supply power to the relay and so the relay does not switch on the heating wire. Therefore, malfunctions of the lifting rack or the motor can be avoided. It can also prevent a slice of bread from getting stuck inside the slot and being immovable, thus reducing the possibility of causing a fire.

The circuit board contains a set of specially designed circuits which controls in a manner that when any fault, abnormality or overheating occurs in the timing or circuit programs of the circuit board, the circuit board sends instructions to cut off the power supply to the heating wire, preventing power from being continuously supplied to the toaster, thus causing fires.

The motor, the set of gears and the set of clutch gears are disposed inside a substantially enclosed casing. The casing is placed on one side of the circuit board. The casing encloses the noise generated by the rotation of the motor, the set of gears and the set of clutch gears, thus having the function of reducing the noise.

Lubricants can be added to the set of gears, the set of clutch gears and the driving gear bar to reduce the frictions among the gears while rotating, thus having the function of reducing the noise and tear and wear of the gears.

To use the toaster, the user inserts the plug to a power socket. Power is supplied to the circuit board through a transformer to reduce the voltage and a set of diode rectifiers to change alternating current to direct current. The user places a slice of bread into the holder in the slot and switch on the toaster. The circuit board receives instructions and sends a “descending signal” of a preset time limit to the motor. The motor then starts to rotate in one direction and drive the endless screw to rotate. The endless screw drives the straight-tooth gears to rotate. The straight-tooth gears drive the set of clutch gears to rotate. The set of clutch gears drives the driving gear bar to move downwards through the clutch straight-tooth gear. The downward movement of the driving gear bar drives the lifting rack and the holder to move downwards until the lower sensor senses the latch of the lifting rack. The lower sensor then sends a “descending completed signal” to the circuit board immediately. The circuit board cuts off the power supply to the motor, and the motor stops rotating and the lifting rack stops descending. The circuit board then sends a “start-to-toast signal”. If the circuit board does not receive any signal from the lower sensor within the preset time limit, the circuit board will automatically cut off the power supply to the motor and will not send any “start-to-toast signal”.

When the circuit board sends a “start-to-toast signal”, the relay is instructed to supply power to the heating wire to heating up and then to toast the slice of bread and at this point of time, the circuit board starts to count the time. Upon expiration of the preset time, the circuit board sends a “toasting completed signal” and cuts off the power supply to the relay and the relay immediately cuts off the power supply to the heating wire, thus preventing the heating wire from heating continuously. The circuit board then sends an “ascending signal” of a preset time limit immediately. The motor starts to rotate in reverse direction and drives the endless screw to rotate in reverse direction. The endless screw then drives the straight-tooth gears to rotate in reverse direction. The straight-tooth gears drive the set of clutch gears to rotate in reverse direction. The set of clutch gears drives the driving gear bar to move upwards through the clutch straight-tooth gear. The upward movement of the driving gear bar drives the lifting rack and the holder to move upwards until the upper sensor senses the latch of the lifting rack. The upper sensor then immediately sends an “ascending completed signal” to the circuit board. The circuit board then cuts off the power supply to the motor, and the motor stops rotating and the lifting rack stops ascending. If the circuit board does not receive any signal from the upper sensor within the preset time limit, the circuit board will automatically cut off the power supply to the motor.

It is an object of the present invention to provide a new internal structure for toasters which has multiple automatic power cut-off devices and is safe and reliable. The usage of a low voltage direct current motor as driving force, a lifting system driven by simple gear transmission mechanism and a noise reducing casing significantly lowers the production costs and reduces the selling price of the final product. The final product is of higher durability which suits the current trend of environmental protection. Moreover, the operation of the present invention is controlled by a circuit board, thus requiring only a few function keys on the casing of the toaster, and so the outlook design is susceptible of more variations and higher aesthetic value. The present invention is suitable for use in family or in the food catering industry.

### BRIEF DESCRIPTION OF THE DRAWINGS

FIG. 1 is the dismantling view of the internal safety structure of a conventional toaster.

FIG. 2 is the perspective view of the internal safety structure of a conventional toaster.

FIG. 3 is the dismantling view of the present invention.

FIG. 4 is the perspective view of the present invention.

FIG. 5 is the circuit diagram of the present invention.

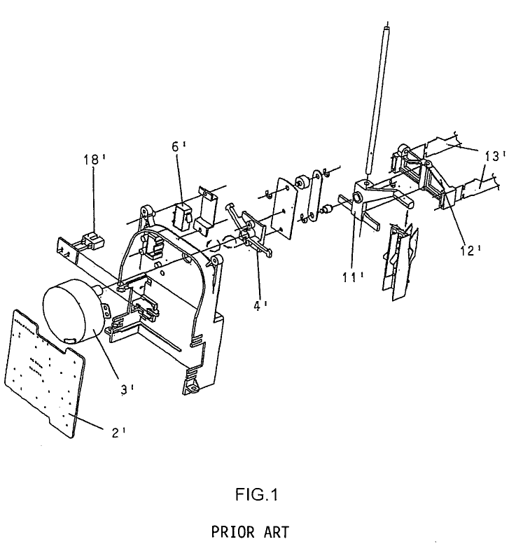

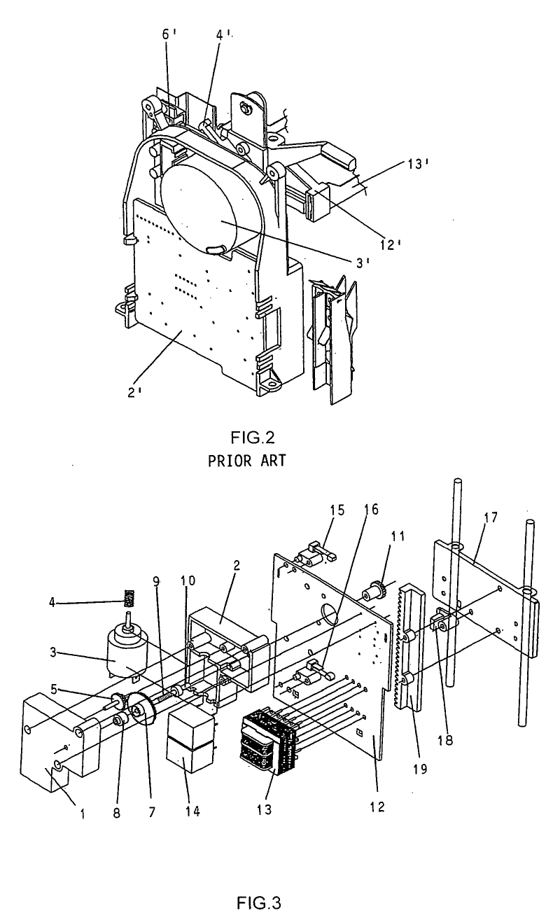

### DETAILED DESCRIPTION OF THE INVENTION

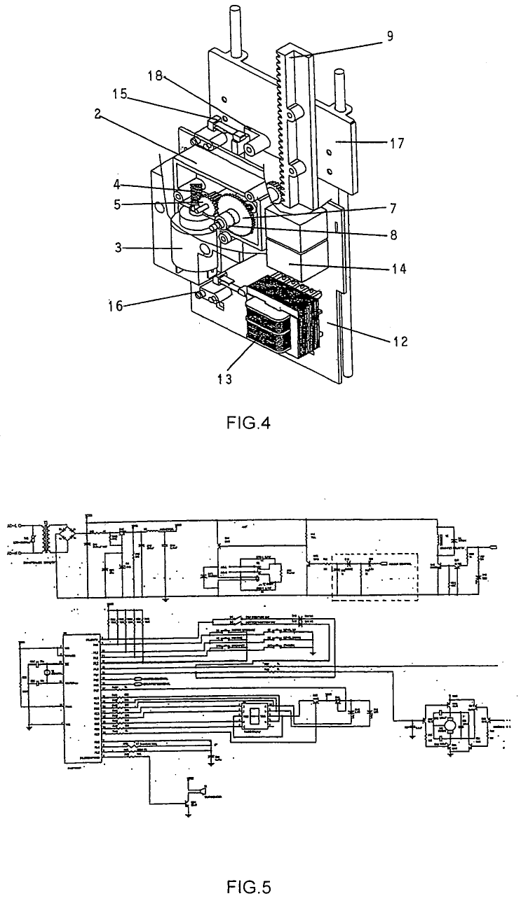

As illustrated in FIGS. 3 to 5, the present invention generally comprises a circuit board 12, a motor 3, a lifting rack 17 and other components. The motor 3 is a low voltage direct current motor which drives the lifting rack 17 to move upwards or downwards through a set of gears, a set of clutch gears and a driving gear bar 19. On the circuit board 12, a transformer 13 is installed to reduce the voltage of the alternating current to supply 6V power, and power is supplied to the circuit board 12 and the motor 3 through a set of diode rectifiers changing the alternating current to direct current.

The set of gears comprises an endless screw 4 which connects and rotates with the motor 3, and two or more straight-tooth gears 5 which are intermeshed with one another and mesh and rotate with the motor 3. One side of the straight-tooth gears 5 meshes with one side of the set of clutch gears. The set of clutch gears comprises a transmission shaft 10 and a clutch straight-tooth gear 11, a clutch spring 9 and two or more intermeshed clutch gears 7, 8 which are installed the transmission shaft 10. One side of the clutch gears 7 meshes with the straight-tooth gear 5. One side of the clutch straight-tooth gear 11 meshes with the driving gear bar 19. When the motor 3 rotates, the set of gears drives one clutch gear 7 in the set of clutch gears to rotate. The rotating clutch gear 7 is pushed by the tension which is created by the clutch spring 9 towards the second clutch gear 8 and drives it to rotate. The second clutch gear 8 drives the clutch straight-tooth gear 11 to rotate through the transmission shaft 10. The clutch straight-tooth gear 11 drives the driving gear bar 19 to move upwards or downwards. One side of the lifting rack 17 connects to a holder placed inside the toaster slots and the other side is connected to the driving gear bar 19. The upward or downward movements of the driving gear bar 19 drive the lifting rack 17 to move upwards or downwards accordingly. The lifting rack 17 drives the slices of bread on the holder to move upwards or downwards accordingly. When the lifting rack 17 is out of order and becomes immovable, the driving gear bar 19 cannot move upwards or downwards and so the clutch straight-tooth gear 11 and the second clutch gear 8 cannot rotate smoothly. When the first clutch gear 7 is driven to rotate by the motor 3 and the set of gears, the first clutch gear 7 compresses the clutch spring 9 and moves away from the second clutch gear 8. The first clutch gear 7 and the second clutch gear 8 skid at the point of contact, thus releasing the driving force generated by the rotation of the motor 3.

The lifting rack 17 has a latch 18 disposed in a position corresponding to the upper sensor 15 and the lower sensor 16. When the lifting rack 17 ascends to a horizontal position corresponding to that of the upper sensor 15, the latch 18 contacts the upper sensor 15 and the upper sensor 15 immediately sends electrical signals to the circuit board 12. The preset programs of the integrated circuit of the circuit board 12 control the motor 3 to stop rotating. The lifting rack 17 is then stopped from ascending continuously. When the lifting rack 17 descends to a horizontal position corresponding to that of the lower sensor 16, the latch 18 contacts the lower sensor 16 and the lower sensor 16 then immediately sends electrical signals to the circuit board 12. The preset programs of the integrated circuit of the circuit board 12 control the motor 3 to stop rotating. The lifting rack 17 is then stopped from descending continuously.

The integrated circuit of the circuit board 12 contains custom software to preset timing for the programs. It automatically cuts off the power supply to the motor 3 after the expiration of the preset time limit of 10 seconds, so as to stop the motor 3 from rotating continuously, thus preventing the motor 3 or other components from malfunctioning.

The power supply of the heating wire uses a relay 14 as a switch. The relay 14 is electrically connected to the power source, the circuit board 12 and the heating wire respectively, and is operated and controlled by the preset programs of the integrated circuit of the circuit board 12. Upon completion of the preset programs, the power supply to the relay 14 is automatically cut off and the relay 14 immediately cuts off the power supply to the heating wire. When the descending procedure of the lifting rack 17 functions improperly, the lower sensor 16 does not send any electrical signal to the circuit board 12, and the circuit board 12 does not supply power to the relay 14 and so the relay 14 does not switch on the heating wire. Therefore, malfunctions of the lifting rack 17 or the motor 3 can be avoided. It can also prevent a slice of bread from getting stuck inside the slot and being immovable, thus reducing the possibility of causing a fire.

The circuit board 12 contains a set of specially designed circuits which controls in a manner that when any fault, abnormality or overheating occurs in the timing or circuit programs of the circuit board 12, the circuit board 12 sends instructions to cut off the power supply to the heating wire, preventing power from being continuously supplied to the toaster, thus causing fires.

The motor 3, the set of gears and the set of clutch gears are disposed inside a substantially enclosed casing 1, 2. The casing 1, 2 is placed on one side of the circuit board 12. The casing 1, 2 encloses the noise generated by the rotation of the motor 3, the set of gears and the set of clutch gears, thus having the function of reducing the noise.

Lubricants can be added to the set of gears, the set of clutch gears and the driving gear bar 19 to reduce the frictions among the gears while rotating, thus having the function of reducing the noise and tear and wear of the gears.

To use the toaster, the user inserts the plug to a power socket. Power is supplied to the circuit board 12 through a transformer 13 to reduce the voltage and a set of diode rectifiers to change alternating current to direct current. The user places a slice of bread into the holder in the slot and switch on the toaster. The circuit board 12 receives instructions and sends a “descending signal” of a preset time limit of 10 seconds to the motor 3. The motor 3 then starts to rotate in one direction and drive the endless screw 4 to rotate. The endless screw 4 drives the straight-tooth gears 5 to rotate. The straight-tooth gears 5 drive the set of clutch gears to rotate. The set of clutch gears drives the driving gear bar 19 to move downwards through the clutch straight-tooth gear 11. The downward movement of the driving gear bar 19 drives the lifting rack 17 and the holder to move downwards until the lower sensor 16 senses the latch 18 of the lifting rack 17. The lower sensor 16 then sends a “descending completed signal” to the circuit board 12 immediately. The circuit board 12 cuts off the power supply to the motor 3, and the motor 3 stops rotating and the lifting rack 17 stops descending. The circuit board 12 then sends a “start-to-toast signal”. The whole process takes about 3 seconds. If the circuit board 12 does not receive any signal from the lower sensor 16 within the preset time limit of 10 seconds, the circuit board 12 will automatically cut off the power supply to the motor 3 and will not send any “start-to-toast signal”.

When the circuit board 12 sends a “start-to-toast signal”, the relay 14 is instructed to supply power to the heating wire to heating up and then to toast the slice of bread and at this point of time, the circuit board 12 starts to count the time. Upon expiration of the preset time, the circuit board 12 sends a “toasting completed signal” and cuts off the power supply to the relay 14 and the relay 14 immediately cuts off the power supply to the heating wire, thus preventing the heating wire from heating continuously. The circuit board 12 then sends an “ascending signal” of a preset time limit of 10 seconds immediately. The motor 3 starts to rotate in reverse direction and drives the endless screw 4 to rotate in reverse direction. The endless screw 4 then drives the straight-tooth gears 5 to rotate in reverse direction. The straight-tooth gears 5 drive the set of clutch gears to rotate in reverse direction. The set of clutch gears drives the driving gear bar 19 to move upwards through the clutch straight-tooth gear 11. The upward movement of the driving gear bar 19 drives the lifting rack 17 and the holder to move upwards until the upper sensor 15 senses the latch 18 of the lifting rack 17. The upper sensor 15 then immediately sends an “ascending completed signal” to the circuit board 12. The circuit board 12 then cuts off the power supply to the motor 3, and the motor 3 stops rotating and the lifting rack 17 stops ascending. If the circuit board 12 does not receive any signal from the upper sensor 15 within the preset time limit of 10 seconds, the circuit board 12 will automatically cut off the power supply to the motor 3.

1. An internal safety structure for toasters comprising a circuit board, a motor, a lifting rack and other components, which is characterized in that the motor is a low voltage direct current motor which drives the lifting rack to move upwards or downwards through a set of gears, a set of clutch gears and a driving gear bar; on the circuit board, an upper sensor and a lower sensor are installed to sense the lifting level of the lifting rack; on the circuit board, there is an integrated circuit which contains custom software to preset the operation and control programs; on the circuit board, a transformer is installed to reduce the voltage of the alternating current, which supplies power to the circuit board and the motor through a set of diode rectifiers changing the alternating current to direct current.

2. An internal safety structure for toasters as in claim 1, wherein the set of gears comprises an endless screw which connects and rotates with the motor, and two or more straight-tooth gears which are intermeshed with one another and mesh and rotate with the motor; and one side of the straight-tooth gears meshes with the set of clutch gears.

3. An internal safety structure for toasters as in claim 1 or 2, wherein the set of clutch gears comprises a transmission shaft and a clutch straight-tooth gear, a clutch spring and two or more intermeshed clutch gears which are installed on the transmission shaft; one side of the clutch gears meshes with the straight-tooth gear; one side of the clutch straight-tooth gear meshes with the driving gear bar; when the motor rotates, the set of gears drives one clutch gear in the set of clutch gears to rotate; the rotating clutch gear is pushed by the tension which is created by the clutch spring towards the second clutch gear and drives it to rotate; the second clutch gear drives the clutch straight-tooth gear to rotate through the transmission shaft; the clutch straight-tooth gear drives the driving gear bar to move upwards or downwards; when the lifting rack is out of order and becomes immovable, the driving gear bar cannot move upwards or downwards and so the clutch straight-tooth gear and the second clutch gear cannot rotate smoothly; when the first clutch gear is driven to rotate by the motor and the set of gears, the first clutch gear compresses the clutch spring and moves away from the second clutch gear; the first clutch gear and the second clutch gear skid at the point of contact, thus releasing the driving force generated by the rotation of the motor.

4. An internal safety structure for toasters as in claim 1, wherein the driving gear bar is connected to the lifting rack securely.

5. An internal safety structure for toasters as in claim 1, wherein the lifting rack has a latch disposed in a position corresponding to the upper sensor and the lower sensor; when the lifting rack ascends to a horizontal position corresponding to that of the upper sensor, the latch contacts the upper sensor and the upper sensor immediately sends electrical signals to the circuit board; the preset programs of the integrated circuit of the circuit board control the motor to stop rotating; the lifting rack is then stopped from ascending continuously; when the lifting rack descends to a horizontal position corresponding to that of the lower sensor, the latch contacts the lower sensor and the lower sensor then immediately sends electrical signals to the circuit board; the preset programs of the integrated circuit of the circuit board control the motor to stop rotating; the lifting rack is then stopped from descending continuously.

6. An internal safety structure for toasters as in claim 1 or 4, wherein one side of the lifting rack connects to a holder placed inside the toaster slots and the other side is connected to the driving gear bar; the upward or downward movements of the driving gear bar drive the lifting rack to move upwards or downwards accordingly; the lifting rack drives the slices of bread on the holder to move upwards or downwards accordingly.

7. An internal safety structure for toasters as in claim 1, wherein the integrated circuit of the circuit board contains custom software to preset timing for the programs; it automatically cuts off the power supply to the motor after the expiration of the preset time limit, so as to stop the motor from rotating continuously; the preset time limit is 5 to 30 seconds.

8. An internal safety structure for toasters as in claim 1, wherein the power supply of the heating wire uses a relay as a switch; the relay is electrically connected to the power source, the circuit board and the heating wire respectively, and is operated and controlled by the preset programs of the integrated circuit of the circuit board; upon completion of the preset programs, the power supply to the relay is automatically cut off and the relay immediately cuts off the power supply to the heating wire; when the descending procedure of the lifting rack functions improperly, the lower sensor does not send any electrical signal to the circuit board, and the circuit board does not supply power to the relay and so the relay does not switch on the heating wire.

9. An internal safety structure for toasters as in claim 1, wherein the circuit board contains a set of specially designed circuits which controls in a manner that when any fault, abnormality or overheating occurs in the timing or circuit programs of the circuit board, the circuit board sends instructions to cut off the power supply to the heating wire.

10. An internal safety structure for toasters as in claim 1 or 2, wherein the motor, the set of gears and the set of clutch gears are disposed inside a substantially enclosed casing; the casing is placed on one side of the circuit board; the casing encloses the noise generated by the rotation of the motor, the set of gears and the set of clutch gears.
